(19) United States
(12) Patent Application Publication
(10) Pub. No.: US 2015/0271477 A1
(43) Pub. Date: Sep. 24, 2015

(54) EXPANDED DISPLAY APPARATUS AND SYSTEM

(71) Applicant: Shenzhen Lexyz Technology Co., Ltd., Shenzhen (CN)

(72) Inventors: ZHANG GE, Shenzhen (CN); LEI SONG, Shenzhen (CN)

(73) Assignee: Shenzhen Lexyz Technology Co., Ltd.

(21) Appl. No.: 14/448,201

(22) Filed: Jul. 31, 2014

(30) Foreign Application Priority Data
Mar. 20, 2014 (CN) 201410108172.0
Mar. 20, 2014 (CN) 201410108202.8
Mar. 20, 2014 (CN) 201420129461.4

(51) Int. Cl. H04N 13/04

(52) U.S. Cl. CPC H04N 13/04; H04N 13/0468

(57) ABSTRACT

An expanded display apparatus to expand display of an electronic display device is provided. The expanded display apparatus includes an upper support member, a lower support member, and a transmissive/reflective device. The upper support member is configured to receive the electronic display device having a display screen for displaying an image by the electronic display device. The transmissive/reflective device is connected between the upper support member and the lower support member. Further, the upper support member and the transmissive/reflective device form a less than 90 degree angle, and the transmissive/reflective device generates a virtual image of the image displayed by the electronic display device, merged with scenes surrounding the expanded display apparatus, to be viewed by a viewer at the viewing angle.

### CROSS-REFERENCES TO RELATED APPLICATIONS

This application claims priority of Chinese Patent Application Numbers CN201410108172.0, CN201410108202.8, and CN201420129461.4, all filed on Mar. 20, 2014, the entire contents of which are incorporated by reference herein.

### FIELD OF THE INVENTION

The present invention generally relates to the field of display technology and, more particularly, to an expanded display apparatus and an expanded display system.

### BACKGROUND

With the development of display technology, high resolution and high chromaticity display can be achieved in a two-dimensional (2D) display device, and the 2D display technology has matured. The new three-dimensional (3D) display technology (also known as stereoscopic display technology or 3D display technology) can bring a strong visual impact to the user, and is an important direction for developing future display technologies.

The 3D display technologies generally include holographic technology, stereoscopic display technology using glasses, and autostereoscopic display technology. Due to the high cost and technical complexity, the commercialization prospects of the holographic technology are significantly limited. Currently, more research is conducted on the glasses-type stereoscopic display technology and the autostereoscopic display technology.

With the glasses-type stereoscopic display, light from two view images with parallax on a display screen is separated by the two lenses of the glasses worn by a user and respectively enters the two eyes of the user. The user's brain can then synthesize the two view images to form a stereoscopic vision. The autostereoscopic display technology uses similar principle, but instead uses a grating on the display screen (commonly a parallax barrier, a lens array, or point backlighting) to separate the light from two view images with parallax on a display screen respectively into the two eyes of the user, then the user's brain can synthesize the two view images to form a stereoscopic vision.

Whether it is the glasses-type stereoscopic display or autostereoscopic display, the display effects of 3D scenes are limited by the display screen frames of the display devices. For example, when displaying a 3D road surface extends toward the front of the display screen on a traditional 3D display device, the 3D road images are limited by the screen frames, the viewer may have a visual experience that the road surface is broken and cannot be extended forwardly. A visual sense of vertigo may be caused, severely affecting the 3D image viewing experience.

The disclosed method and device are directed to solve one or more problems set forth above and other problems.

### BRIEF SUMMARY OF THE DISCLOSURE

One aspect of the present disclosure includes an expanded display apparatus to expand display of an electronic display device. The expanded display apparatus includes an upper support member, a lower support member, and a transmissive/reflective device. The upper support member is configured to receive the electronic display device having a display screen for displaying an image by the electronic display device. The transmissive/reflective device is connected between the upper support member and the lower support member. Further, the upper support member and the transmissive/reflective device form a less than 90 degree angle, and the transmissive/reflective device generates a virtual image of the image displayed by the electronic display device, merged with scenes surrounding the expanded display apparatus, to be viewed by a viewer at the viewing angle.

Another aspect of the present disclosure includes an expanded display apparatus to expand display of an electronic display device. The expanded display apparatus includes a support member and a transmissive/reflective device. The support member is configured to receive the electronic display device having a display screen for displaying an image by the electronic display device. The transmissive/reflective device is connected to the support member with a less than 90 degree angle. The transmissive/reflective device generates a virtual image of the image displayed by the electronic display device, merged with scenes surrounding the expanded display apparatus, to be viewed by a viewer at the viewing angle.

Another aspect of the present disclosure includes an expanded display system. The expanded display system includes an electronic display device and an expanded display apparatus to expand display of the electronic display device. The electronic display device has a display screen for displaying an image by the electronic display device. The expanded display apparatus includes a first support member and a transmissive/reflective device. The first support member is configured to receive an electronic display device, and the transmissive/reflective device is connected to the first support member with a less than 90 degree angle. The transmissive/reflective device generates a virtual image of the image displayed by the electronic display device, merged with scenes surrounding the expanded display apparatus, to be viewed by a viewer at the viewing angle.

Other aspects of the present disclosure can be understood by those skilled in the art in light of the description, the claims, and the drawings of the present disclosure.

### BRIEF DESCRIPTION OF THE DRAWINGS

In order to describe the technical solution of the embodiments of the present invention more clearly, drawings used in the description of the embodiments are briefly described below, which are merely some exemplary embodiments of the present invention. For those skilled in the art, without inventive effort, other drawings may also be obtained according to these drawings and the descriptions included herein.

FIG. 1 illustrates an exemplary expanded display apparatus consistent with the disclosed embodiments;

FIG. 2 illustrates another exemplary expanded display apparatus consistent with the disclosed embodiments;

FIG. 3 illustrates another exemplary expanded display apparatus consistent with the disclosed embodiments;

FIG. 4 illustrates an exemplary imaging process consistent with the disclosed embodiments;

FIG. 5 illustrates another exemplary expanded display apparatus consistent with the disclosed embodiments;

FIG. 6 illustrates another exemplary expanded display apparatus consistent with the disclosed embodiments;

FIG. 7a illustrates an imaging process of a conventional autostereoscopic display apparatus;

FIG. 7b illustrates an imaging process of the disclosed display apparatus for autostereoscopic display consistent with disclosed embodiments;

FIG. 8 illustrates another exemplary expanded display apparatus consistent with the disclosed embodiments;

FIG. 9 illustrates a block diagram of an exemplary expanded display apparatus consistent with the disclosed embodiments;

FIGS. 10a, 10b, and 10c illustrate exemplary applications of controlling the electronic display device consistent with disclosed embodiments;

FIG. 11 illustrates an imaging process of the display system using 3D glasses consistent with disclosed embodiments;

FIGS. 12a and 12b illustrate an exemplary expanded display apparatus consistent with disclosed embodiments;

FIG. 13 illustrates another exemplary expanded display apparatus consistent with the disclosed embodiments; and

FIG. 14 illustrates an exemplary expanded display system consistent with the disclosed embodiments.

### DETAILED DESCRIPTION

Reference will now be made in detail to exemplary embodiments of the invention, which are illustrated in the accompanying drawings. It should be noted that, without any conflict, features described in the disclosed embodiments can be combined or interchanged.

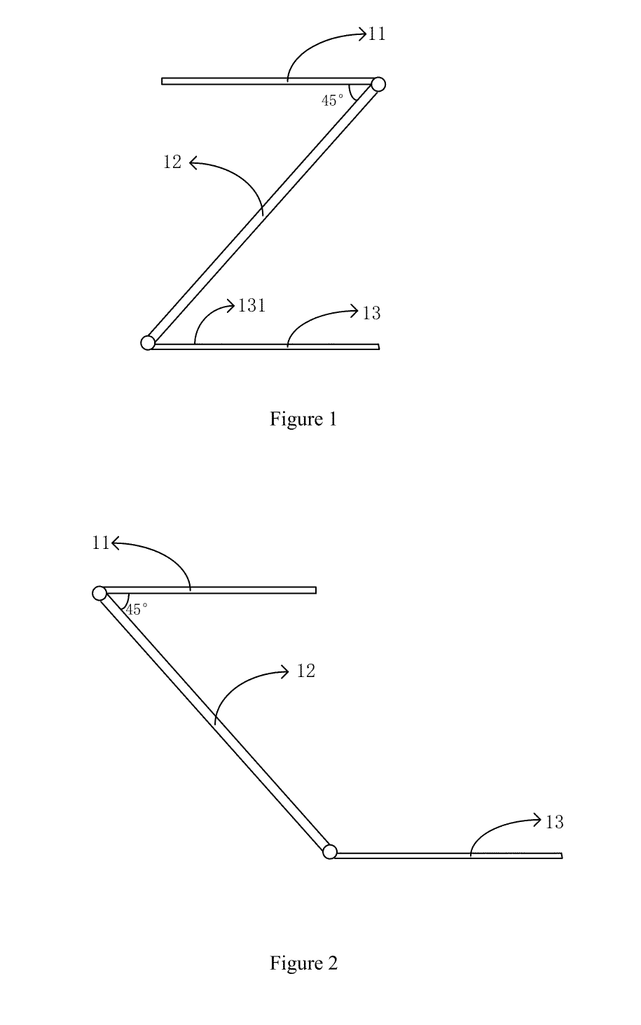

To overcome the limitations by the display frames of traditional 3D display devices, an expanded display system is disclosed to expand the displayed 3D images into scenes surrounding the 3D display devices, including real world scenes. That is, the expanded display system expands the display of an electronic display device in the expanded display system. FIG. 1 illustrates an exemplary expanded display apparatus.

As shown in FIG. 1, the expanded display apparatus includes an upper support member 11, a lower support member 13, and a transmissive/reflective device 12 coupled between the upper support member 11 and the lower support member 13. Other components may also be included.

The upper support member 11 may be configured to receive an electronic display device. Specifically, the structure of the upper support member 11 may be designed according to the structure of the electronic display device such that the electronic display device can be placed on the upper support member 11 or inside the upper support member 11. The electronic display device may include any appropriate electronic device having 2D or 3D display functions, such as mobile phone, smart phone, tablet computer, digital book reader, notebook computer, game console, and any other type of device. In one embodiment, the upper support member 11 may be a support frame matching the shape and size of the electronic display device.

The transmissive/reflective device 12 may be a transmissive/reflective lens (e.g., a half-transmissive and half-reflective lens) with a same width as the upper support member 11. The transmissive/reflective device 12 may have a flat plane shape, a curved plane shape, or other frameless geometrical plane shape, and may include a first surface and a second surface. The transmissive/reflective ratio of the transmissive/reflective device 12 may be adjustable, and the size of the transmissive/reflective device 12 may be decided based on screen size of images to be displayed.

The transmissive/reflective device 12 may be made of any appropriate material simultaneously having transmissive and reflective functionalities or other materials coated with the material having both transmissive and reflective functionalities, such as glass, plastic, or acrylic plate, etc. The transmissive/reflective device 12 may also be an electrically controlled transmissive/reflective screen, such as an electronically controlled liquid crystal panel, etc.

Further, the transmissive/reflective effects of the transmissive/reflective device 12 may be significantly affected by light conditions. For example, the image contrast may be significantly worse when viewed in outdoor with strong daylight. In certain embodiments, the transmissive/reflective device 12 (e.g., the glass of transmissive/reflective device 12) may be coated with a photochromic material layer or the glass used to manufacture the transmissive/reflective device 12 may be added with the photochromic material.

The photochromic material may have two different molecular or electron structure states, and there are two different absorption coefficients in the visible light spectrum region. Under the light, one structure can be converted into the other structure. Thus, the photochromic material can change its light transmittance under the light. For example, under the strong sunlight containing ultraviolet light, the light transmittance of the glass added with the photochromic material decreases, and the image contrast can be maintained. In the indoor environment, the light transmittance increases to ensure desired display effect. In one embodiment, the photochromic material may be halide.

The lower support member 13 is provided for supporting the upper support member 11 and/or the transmissive/reflective device 12. The lower support member 13 may be a supporting surface or supporting frame placed horizontally or in parallel to the upper support member 11. The upper support 11 and lower support member 13 may be placed on different sides of the transmissive/reflective device 12, as shown in FIG. 1. The upper support member 11 and the lower support member 13 can also be placed at the same side of the transmissive/reflective device 12, as shown in FIG. 2.

Further, the upper support member 11 may form an acute angle (less than 90 degrees) with the transmissive/reflective device 12, preferably between 30 to 60 degrees (a 45-degree angle is shown in both FIG. 1 and FIG. 2). The upper support member 11 and the transmissive/reflective device 12 may be connected by a fixed connecting structure, such as matched insertion, or by a moveable connecting structure for the user to adjust the viewing angle.

Further, the moveable connecting structure can be realized by a positioning shaft on the upper support member 11 and a positioning sleeve on the transmissive/reflective device 12. Specifically, the positioning shaft has a positioning protrusion, and a corresponding positioning groove is located on the inner side of the positioning sleeve. The positioning shaft can be inserted into the positioning sleeve with the positioning protrusion engaged in the positioning groove.

Alternatively, the positioning shaft may be disposed on the transmissive/reflective device 12, and the corresponding positioning sleeve may be disposed on the upper support member 11. Other structures may also be used for the moveable connecting structure, including other rotary positioning structures, such hinge structures. The lower support member 13 may also be connected to the transmissive/reflective device 12 using the above described fixed connecting structures and moveable connecting structures.

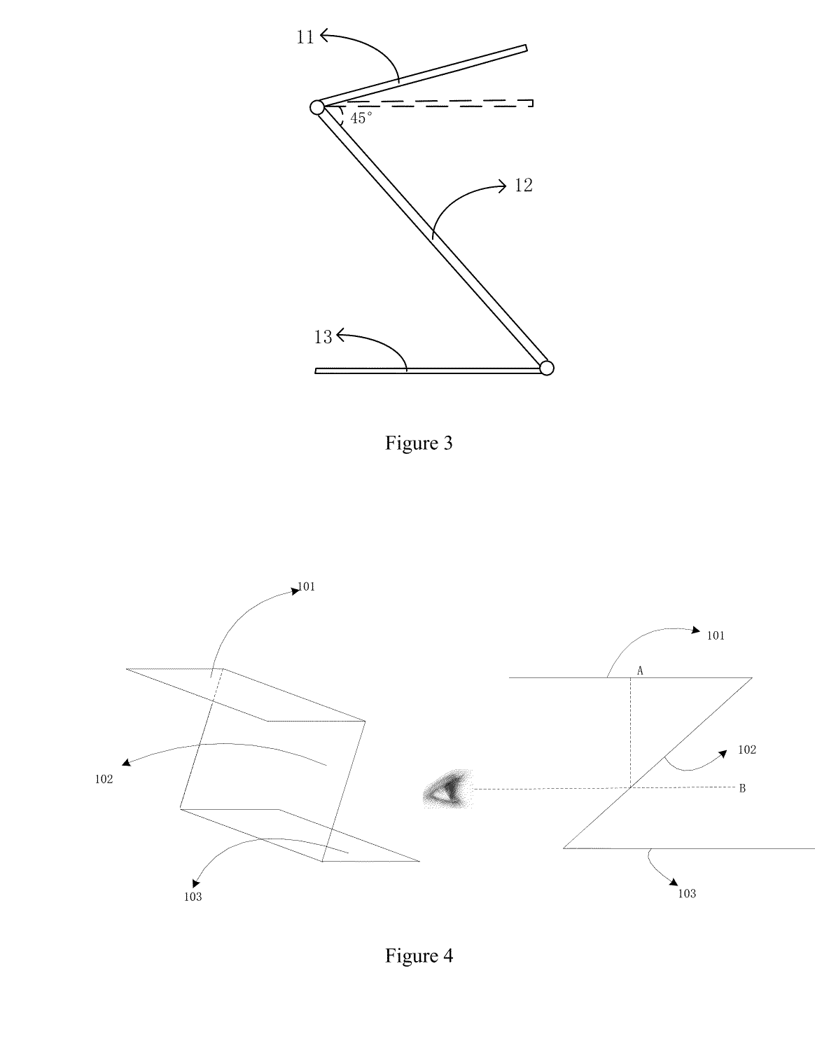

Both of the connection between the upper support member 11 and the transmissive/reflective device 12 and the connection between the transmissive/reflective device 12 and the lower support member 13 may be fixed connections. Also, one of the connections may be fixed connection and the other one may be moveable connection. As shown in FIG. 3, the lower support member 13 is fixedly connected to the transmissive/reflective device 12, while the upper support member 11 is moveably connected to the transmissive/reflective device 12. The user can adjust the angle between the upper support member 11 and the transmissive/reflective device 12 to adjust the viewing angle.

Alternatively, the lower support member 13 is moveably connected to the transmissive/reflective device 12, while the upper support member 11 is fixedly connected to the transmissive/reflective device 12. In addition, both of the connection between the upper support member 11 and the transmissive/reflective device 12 and the connection between the transmissive/reflective device 12 and the lower support member 13 may be moveable connections. The user can flexibly adjust the viewing angle, and also can fold the upper support member 11 and the lower support member 13 to save space for storage and travel.

When being used, the upper support member 11 is located on a first side of the transmissive/reflective device 12, and the lower support member 13 is located on a second side of the transmissive/reflective device 12. When the electronic display device is placed in the upper support member 11 and facing the transmissive/reflective device 12, a virtual image of the image displayed on the electronic display device can be generated at the second side of the transmissive/reflective device 12, i.e., the opposite side to the upper support member 11. That is, the display on the electronic display device is expanded by the transmissive/reflective device 12 to form the expanded display.

Further, the surface 131 of the lower support member 13, facing the transmissive/reflective device 12, may include a light-absorbing layer (not shown). The light-absorbing layer is disposed on the surface of the lower support member 13 to absorb the light passing through the transmissive/reflective device 12 during image display, so as to prevent the passing light from being reflected back, thereby affecting the contrast and brightness of the virtual image and the visual experience.

FIG. 4 illustrates an exemplary imaging process of a 2D display. The electronic display device is capable of displaying 2D images, such as a mobile phone, a computer, a game console, and so on.

As shown in FIG. 4, plane 101 is the plane where the upper support member 11 is located, plane 102 is the plane where the transmissive/reflective device 12 is located, and plane 103 is the plane where the lower support member 13 is located. When the electronic display device (e.g., a mobile phone) is placed on the upper support member 11, i.e., the display screen of the mobile phone is on the plane 101, light from a point A on the display screen, representing the signal strength of the point A, is reflected into the eyes of the user via the transmissive/reflective device 12 on the plane 102.

Because the angle between the upper support member 11 and the transmissive/reflective device 12 is less than 90 degrees, the user can see the image of A on the display screen of the electronic display device from the point B behind the transmissive/reflective device 12. Further, because the transmissive/reflective device 12 is also transmissive, the user can also see real objects and scenes behind the transmissive/reflective device 12, forming a display effect combining the virtual image and the real scene together. That is, the image displayed by the electronic display device is expanded to include not only the image itself but also the real scene surrounding the expanded display apparatus.

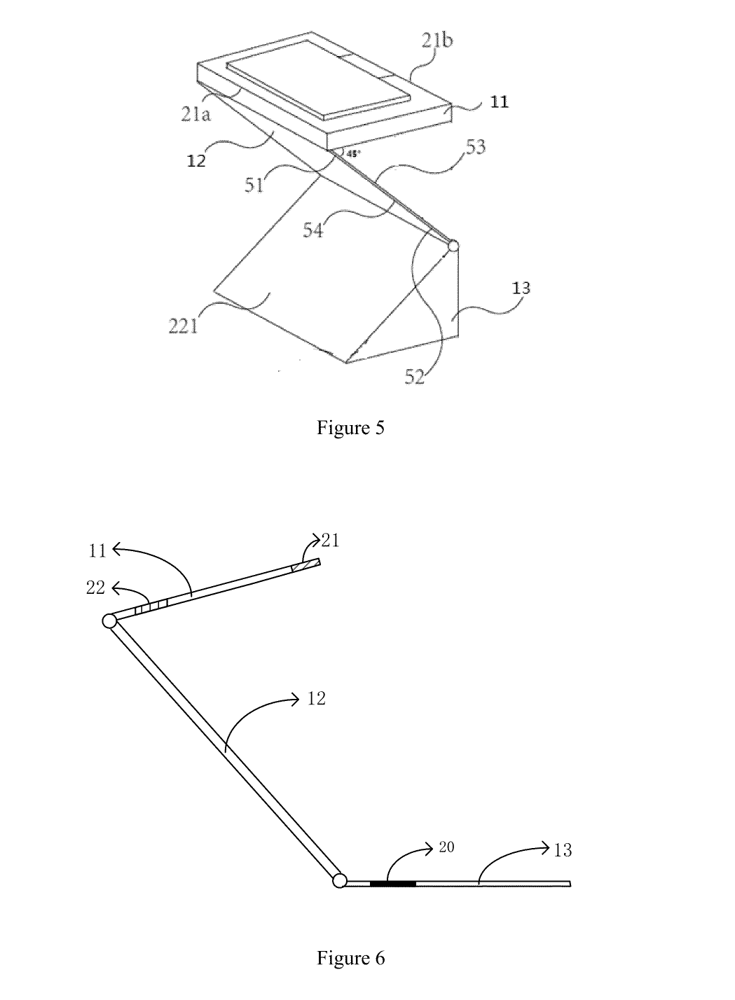

FIG. 5 illustrates another exemplary expanded display apparatus. As shown in FIG. 5, the expanded display apparatus includes a first receiving structure 11, a second receiving structure 13, a first connecting structure (not shown), a moveable connecting structure, and a transmissive/reflective device 12. Other components may also be included.

The first receiving structure 11 may be used for receiving the electronic display device. The first receiving structure 11 includes a connecting end 21a and a free end 21b opposite to the connecting end 21a. The transmissive/reflective device 12 includes a first end 51 and a second end 52 opposite to the first end 51. The transmissive/reflective device 12 also includes a first surface 53 and a second surface 54 opposite to the first surface 53. The first surface 53 faces the first receiving structure 11, and the second surface 54 faces the second receiving structure 13. The first end 51 of the transmissive/reflective device 12 is connected to the connecting end 21a of the first receiving structure 11 by the first connecting structure, and the second end 52 of the transmissive/reflective device 12 is moveably connected to the second receiving structure 13 by the connecting structure. During display operation, a virtual image of the image displayed by the electronic display device is generated on the side of the second surface 54 of the transmissive/reflective device 12.

The first receiving structure 11 may include a hollow frame, and the frame form a receiving space for housing the electronic display device. That is, the hollow portion of the frame forms the receiving space such that the electronic display device can be placed in the first receiving structure 11. The receiving space matches the electronic display device.

The shapes and structures of the first receiving structure 11 are not limited, as long as the first receiving structure 11 can accommodate the electronic display device and expose the display surface of the electronic display device, facing the transmissive/reflective device 12, such that the light of the displayed image on the electronic display device can pass through the transmissive/reflective device 12 to form a virtual image on the side of the second surface 54 of the transmissive/reflective device 12.

The second receiving structure 13 may be a hollow triangular prism or a hollow rectangular box body, and may be used to contain other parts or accessories of the electronic display device, such as such as manuals, ear plugs, and USB cables, etc.

Further, the second receiving structure 13 may also include a light-absorbing layer (not shown). The light-absorbing layer is disposed on the surface 221 of the second receiving structure 13 on the side of the second surface 54 of the transmissive/reflective device 12. The light-absorbing layer is used to absorb the light passing through the transmissive/reflective device 12 during image display, so as to prevent the passing light from being reflected back, thereby affecting the contrast and brightness of the virtual image and the visual experience.

The first connecting structure may be a fixed connecting structure, i.e., the connecting end 21a of the first receiving structure 11 is fixedly connected to the transmissive/reflective device 12 via the fixed connecting structure, and the display surface of the electronic display device placed into the first receiving structure forms a certain angle with the first surface 53 of the transmissive/reflective device 12. The angle may be an acute angle, in a range of 30 degrees to 60 degrees. In one embodiment, the angle is approximately 45 degrees. The fixed connecting structure may include various fixed structure, such as a fixed slide-luck structure.

The moveable connecting structure between the transmissive/reflective device 12 and the second receiving structure 13 may include a connecting positioning shaft on the edge of the second end 52 of the transmissive/reflective device 12 and a connecting positioning sleeve on the second receiving structure 13. The positioning shaft has a positioning protrusion, and a corresponding positioning groove is located on the inner side of the positioning sleeve. The positioning shaft can be inserted into the positioning sleeve, with the positioning protrusion engaged in the positioning groove.

Alternatively, the positioning shaft may be disposed on the receiving structure 13, and the corresponding positioning sleeve may be disposed on the second end 54 of the transmissive/reflective device 12. Also, the positioning protrusion may be located on the positioning sleeve and the corresponding positioning groove may be located on the positioning shaft. Other structures may also be used for the moveable connecting structure, including other rotary positioning structures, such hinge structures.

The transmissive/reflective device 12 may be a device that has a surface coating and whose transmissive/reflecting ratio can be adjusted according to the ambient light. With a power supply, the transmissive/reflective device 12 can also be a liquid crystal glass device (also known as electronically-controlled liquid crystal glass). When power is applied, the transmissive rate (or transmittance) can be adjusted by adjusting the voltage of the device to adapt to changing light environment.

In operation, the electronic display device is initially packed inside the first receiving structure 11 and in a non-display state. The followings describe in detail on how the display device changes from a non-display state to a display state.

When an external force is being applied on the first receiving structure 11, the first receiving structure 11 can bring the transmissive/reflective device 12 to rotate with respect to the second receiving structure 11. That is, the transmissive/reflective device 12 rotates with respect to the second receiving structure 13 through the first connecting structure. Thus, a space can be formed between the first receiving structure 11 and the first surface 53 of the transmissive/reflective device 12, and a space is also formed between the second receiving structure 13 and the second surface 54 of the transmissive/reflective device 12.

When the display screen or display surface of the electronic display device contained in the first receiving structure 11 forms a 45-degree angle with respect to the first surface 53 of the transmissive/reflective device 12, and the second surface 54 of the transmissive/reflective device 12 forms a 45-degree angle with respect to the surface of the second receiving structure 13, the generated virtual image on the side of the second surface 54 may be the same size as the image displayed on the electronic display device.

In one embodiment, the first receiving structure 11 may be a rectangular prism shape, and the second receiving structure 13 may be a triangular prism shape. Thus, the light from the display screen of the electronic display device does not affect a viewer's viewing experience on the virtual images. That is, the light from the display screen of the electronic display device does not affect the contrast and brightness of the virtual images, the expanded display apparatus can be placed more stably and with more desired appearance.

Further, the expanded display apparatus may also include a viewing angle adjustment mechanism. The viewing angle adjustment mechanism may be realized by the moveable connecting structure, e.g., by rotating the transmissive/reflective device 12 with respect to the second receiving structure 13 to adjust the viewing angle, as shown in FIG. 6. Further, the viewing angle adjusting mechanism may be disposed at the bottom of the second receiving structure 13, such that all of the first receiving structure 11, the transmissive/reflective device 12, and the second receiving structure 13 can rotate with respect to the viewing angle adjusting mechanism, and the positions among the first receiving structure 11, the transmissive/reflective device 12, and the second receiving structure 13 are kept unchanged. Thus, the imaging space of the virtual images is not changed while realizing the viewing angle adjustment functionalities.

Further, when in a non-display state, the first receiving structure 11 can be used to contain the electronic display device, and the second receiving structure 13 can be used to contain accessories of the electronic display device, for storing and packaging the electronic display device and for making it easier to carry.

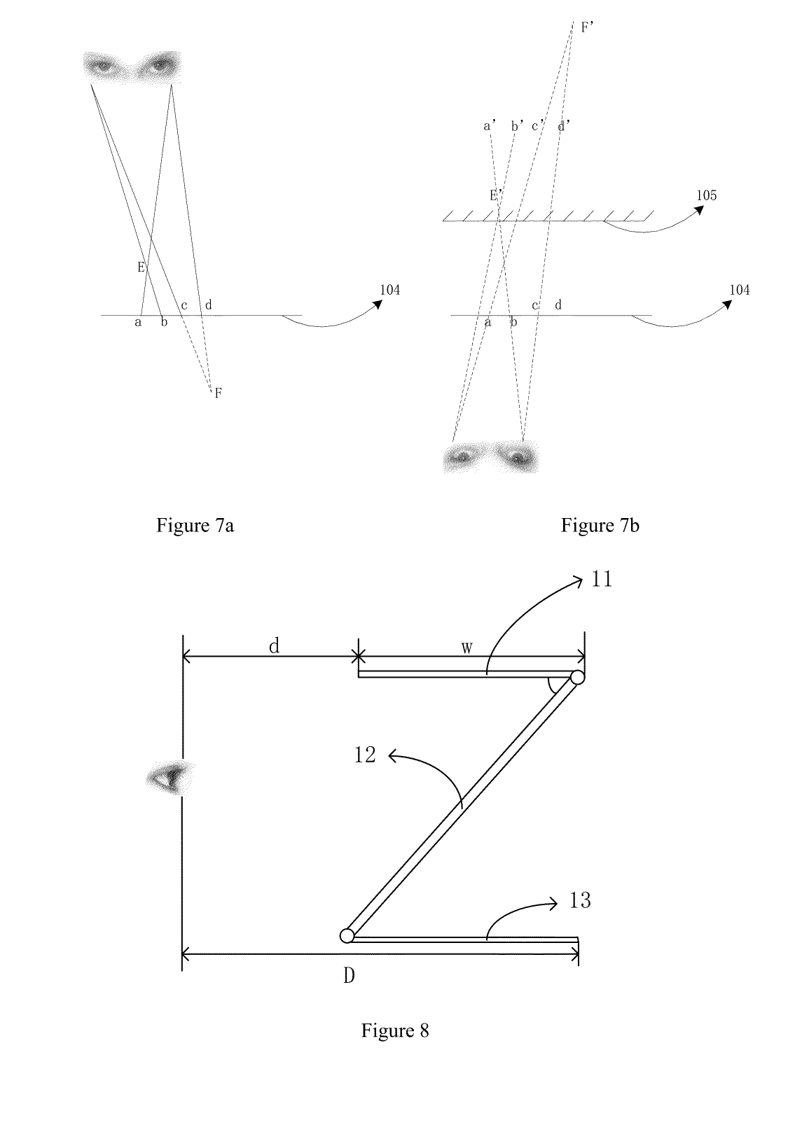

FIG. 7a shows an imaging process of a conventional autostereoscopic display apparatus, and FIG. 7b shows an imaging process of the disclosed expanded display apparatus for autostereoscopic display. The electronic display device is capable of displaying 3D images, such as a mobile phone, a computer, a game console, and so on.

As shown in FIG. 7a, the 3D image includes a left view image for the left eye and a right view image for the right eye with a parallax between the left view image and the right view image. The plane 104 represents the screen of the electronic display device, ‘a’ and ‘b’ represent a point in the left view image and a point in the right image corresponding to a same point in an actual scene, and ‘c’ and ‘d’ represent another point in the left view image and another point in the right image corresponding to another same point in the actual scene.

Light from points ‘a’, ‘b’, ‘c’, and ‘d’ passes through a directional light splitting device, such as a lens array or a parallax barrier, etc., enters into the viewer's left eye and right eye, respectively, which is then synthesized by the viewer's brain into ‘E’ and ‘F’ two points with three-dimensional effect.

As shown in FIG. 7b, assuming that the transmissive/reflective device 12 is placed parallel to the first receiving structure 11, which is equivalent to placing a transmissive/reflective lens surface 105 in parallel to the plane 104 in FIG. 7a. Thus, light from the point ‘a’ passes through the transmissive/reflective lens surface 105 to form an image point a′. Similarly, points b′, c′, and d′ are image points of ‘b’, ‘c’, and ‘d’, respectively. The viewer then can see 3D image points E′ and F′ through the transmissive/reflective lens surface 105.

Comparing the three-dimensional display effect of the two display apparatus, the positions E′ and F′ in FIG. 7b are mirror images of the points E and F in FIG. 7a along the horizontal center axis. Thus, in FIG. 7b, the viewer can see a reversed or upside-down image of the image displayed on the electronic display device.

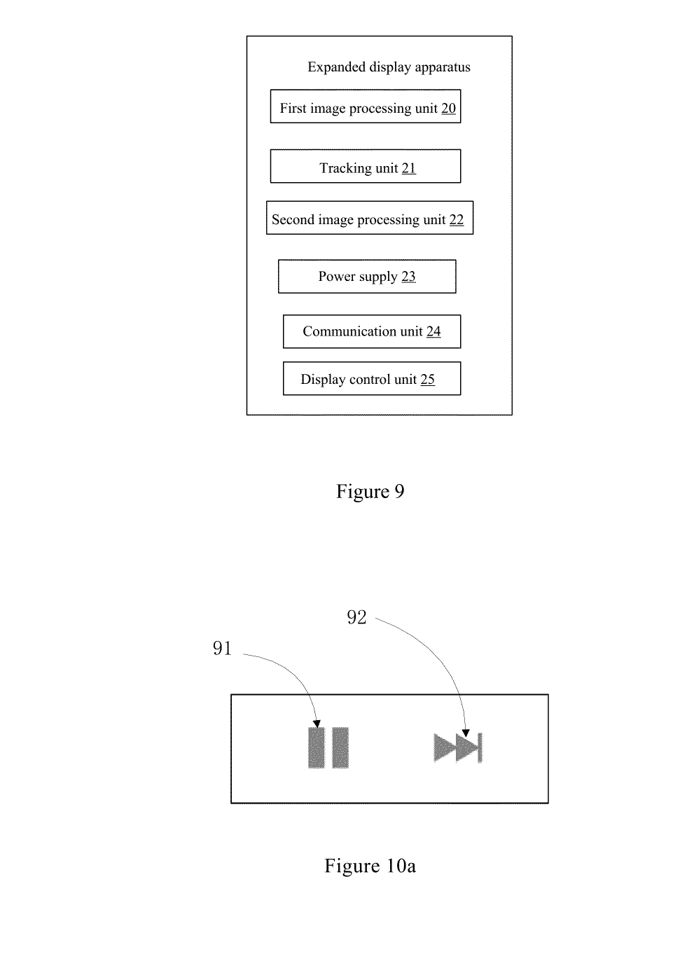

FIG. 9 illustrates a block diagram of a corresponding expanded display apparatus. As shown in FIG. 9, the expanded display apparatus may includes a first image processing unit 20.

The first image processing unit 20 may be configured to perform a mirror image processing along the horizontal center axis on the image to be displayed by the electronic display device, such that the virtual image can be viewed by the viewer as a normal image.

Specifically, assuming the number of pixels on the horizontal direction of each image displayed on the electronic display device is W, then the pixel value of any pixel in the image A (Xa, Ya) can be interchanged with the pixel value of the pixel B (W-Xa, Ya). As shown in FIGS. 7a and 7b, because the imaging function of the transmissive/reflective lens surface 105, the positions of the image pints E and F without the transmissive/reflective lens surface 105 and the positions of the image points E ‘and F’ with the transmissive/reflective lens surface 105 are interchanged in the horizontal direction. After the mirror image processing by the first image processing unit 20, the horizontal interchange can be performed first, and the correct display can be obtained after the imaging by the transmissive/reflective lens surface 105.

It should be noted that the above notation uses the image coordinates starting from ‘1’, and the pixel value of the image point A(Xa, Ya) is interchanged with the pixel value of the image point B(W-Xa, Ya). For image coordinates starting from ‘0’, the pixel value of the image point A(Xa, Ya) is interchanged with the pixel value of the image point B(W-1-Xa, Ya).

Thus, using the first image processing unit 20 of the expanded display apparatus, the image displayed by the electronic display device is mirror image processed along the horizontal center axis to ensure the viewer can view a correct display. Because the transmissive/reflective lens surface 105 not only has reflective functionality, but also has transmissive functionality, the view can view real world scene through the transmissive/reflective lens surface 105 in addition to the virtual 3D images. Thus, the virtual 3D image and the real world scene can then be integrated together, giving the viewer a realistic and immersive feel and improving the viewer's viewing experience.

Further, as shown in FIG. 9, the expanded display apparatus also includes a tracking unit 21 and a second image processing unit 22. The tracking unit 21 is provided for tracking the position of the viewer. Specifically, the tracking unit 21 may be a camera disposed on an appropriate location of the expanded display apparatus (e.g., on the upper support member 11 and facing the viewer). The tracking unit 21 may collect feature information of the facial region of the viewer to track and determine the position of the viewer's eyes.

The tracking unit 21 is electrically coupled to the second image processing unit 22, and sends the position information of the viewer to the second image processing unit 22. Based on the position information of the viewer, the second image processing unit 22 rearranges the image information to be displayed by the electronic display device, so as to achieve expanded display with large viewing angles. In certain embodiments, as shown in FIG. 8, a viewing distance ‘D’ is the sum of a distance ‘d’ between the viewer and the camera and the width ‘w’ of the display region of the electronic display device, D=d+w.

Further, as shown in FIG. 9, the expanded display apparatus also includes a power supply 23 and a communication unit 24 disposed on the upper support member 11 or the lower support member 13. When the transmissive/reflective device 12 is a device that needs power, such as an electronically-controlled transmissive/reflective device (e.g., an electronically-controlled liquid crystal glass), the power supply 23 may be connected to the transmissive/reflective device to supply power. In addition, the power supply 23 may also be connected to the communication unit 24.

The communication unit 24 may also be used to electrically connect the expanded display apparatus with the electronic display device, and the power supply 23 can provide power to the electronic display device connected to the expanded display apparatus via the communication unit 24. In addition, the communication unit 24 can also be used to provide data exchange between the expanded display apparatus and the electronic display device.

Specifically, the communication unit 24 may be a USB unit disposed on the upper support member 11 or the lower support member 13. The USB unit may include a control unit and a USB interface. The USB control unit controls the USB unit, and the USB interface can be connected to a USB interface of the electronic display device, for data exchange. The power supply 23 can charge the electronic display device through the USB interface, and the expanded display apparatus can perform information operations, such as downloading files and copying from the electronic display device. In certain embodiments, the communication unit 24 may be one or more of a WIFI communication unit, an NFC (Near Field Communication) communication unit, an RFID communication unit, a Bluetooth communication unit, and a compression sensor device, etc.

Further, the communication unit 24 can also be connected to the tracking unit 21, such as a camera, and the second image processing unit 22 may be provided in the electronic display device. The camera can establish a communication link with the electronic display device via the USB interface, and send the position information of the viewer to the second image processing unit 22.

Further, as shown in FIG. 9, the expanded display apparatus may also include a display control screen 25 disposed on a surface of the lower support member 13 facing the viewer, and the display control screen 25 is connected to the power supply 23 for power. The display control screen 25 may also be connected with the communication unit 24 to achieve data transmission and interactive control with the electronic display device.

For example, the display control screen may be used to display control information corresponding to the images displayed by the electronic display device. Specifically, the control information can be control keys, such as the fast-forward key or the rewind key when the electronic display device is playing back video or music, etc., or the page turning key or webpage link when the electronic display device is displaying webpage, or the connect key when the electronic display device is connected. Using mobile phone as an example, it can be connected when it is turned on or is called. The user can operate the display control screen 25 to control the content displayed by the electronic display device, i.e., to control the fast-forward or rewind of the video or music, to open a webpage link, or to connect the electronic display device.

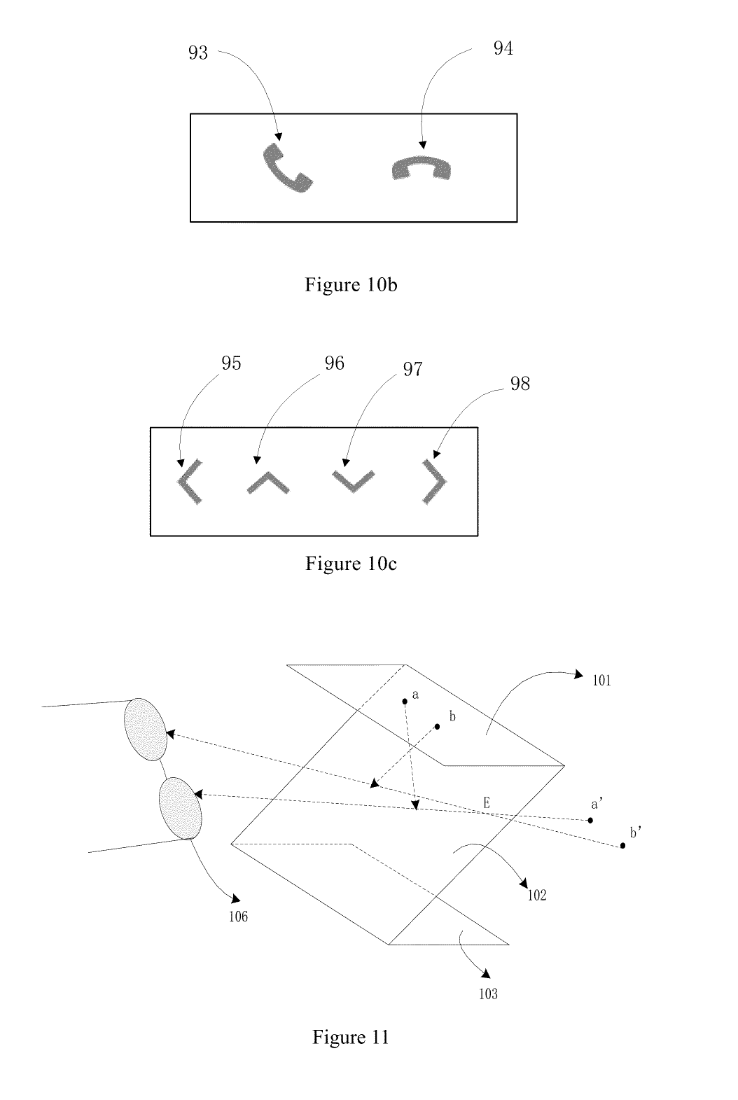

FIGS. 10a, 10b, and 10c show exemplary applications of controlling the electronic display device through the display control screen 25. The display control screen 25 may be a touch display screen or a display screen with physical keys. For illustrative purposes, a touch display screen is used. FIG. 10a shows a diagram of control information displayed on the display control screen 25 for the electronic display device when playing back music. FIG. 10b a diagram of control information displayed on the display control screen 25 for the electronic display device when receiving a call. FIG. 10c shows a diagram of control information displayed on the display control screen 25 for the electronic display device when displaying a webpage.

As shown in FIG. 10a, when the electronic display device is playing back music, the electronic display device transmits to the expanded display apparatus information for controlling the music playback. After receiving the information for controlling the music playback, the expanded display apparatus generates corresponding icons for controlling the music playback, and displays the control icons on the display screen of the touch screen 25. The icons may include a virtual key 91 for controlling play/pause of the music, and a virtual key 92 for fast forwarding to next music piece. When the user wants to pause the music playback, the user touches the virtual key 91. After receiving the control information inputted by the user, the expanded display apparatus sends the corresponding control instruction to control the electronic display device to pause the music playback. When the user wants to listen to the next song, similarly, the user touches the virtual key 92. After receiving the control information inputted by the user, the expanded display apparatus sends the corresponding control instruction to control the electronic display device to switch to the next music piece.

As shown in FIG. 10b, similarly, when the electronic display device is a mobile communication terminal, if the mobile communication terminal is called, the mobile communication terminal transmits the control information related to the call to the expanded display apparatus. After receiving the control information of the call, the expanded display apparatus generates virtual keys 93 and 94 on the touch screen 25. The virtual key 93 is an answer key, and the virtual key 94 is a hang-up key. Based on actual needs, a user can touch a corresponding virtual key, and the expanded display apparatus sends corresponding control information to the electronic display device to answer the call or to hang up the call. Further, in addition to the virtual keys 93 and 94, the electronic display device can also send basic information of the caller, such as contact name, phone number, etc., to the expanded display apparatus. The expanded display apparatus can display the received basic information of the contact on the touch screen. Thus, when the user views from the expanded display apparatus the image displayed by the electronic display device, the user does not need to hurry to pick up the electronic display device to operate, increasing the user's convenience.

Similarly, as shown in FIG. 10c, when the user browses Internet news by a network connection through the electronic display device, the expanded display apparatus displays the webpage displayed by the electronic display device. The electronic display device sends the control information of the webpage to the expanded display apparatus. After receiving the control information of the webpage, the expanded display apparatus displays on the touch screen the corresponding virtual keys 95, 96, 97, and 98. The virtual key 95 is a ‘Backward’ key, the virtual key 96 is a ‘UP’ key, the virtual key 97 is a ‘Down’ key, and the virtual key 98 is a ‘Forward’ key. Using these virtual keys 95, 96, 97, and 98, the user can freely browse the webpage. Further, in addition to the virtual keys 95, 96, 97, and 98, the electronic display device can also send website information to the expanded display apparatus. The expanded display apparatus can display the received website information on the touch screen. The website information may include web address and website name, etc. The user can also enter website information on the touch screen on the expanded display apparatus to realize the equivalent effect of entering information on the electronic display device. For example, the touch screen can display a web address input field. When the user selects the input field, a virtual keyboard can pop-up for user input. Such webpage control method may bring a new experience for the users.

Further, the power supply 23, the tracking unit 21, the communication unit 24, and the display control screen 25 may be disposed on the edge of the upper support member 11 and the lower support member 13 of the expanded display apparatus. Connecting wires are arranged along the edges of the upper support member 11, the transmissive/reflective device 12, and the lower support member 13 to connect at least two the above units.

Specifically, the power supply 23 may be disposed on the edge of the lower support member 13, and the display control screen 25 is disposed on the surface of the lower support member 13 facing the user. The connecting wires are arranged along the edge of the lower support member 13, the edge of the transmissive/reflective device 12, and the edge of the upper support member 11 to connect the USB interface on the edge of the upper support member 11 and the camera. In operation, the user places the electronic display device on the upper support member 11, and the electronic display device is connected to the camera and the power supply 23 through the USB interface.

It should be noted that the first image processing unit 20 and the second image processing unit 22 may be realized in hardware, such as in a chip, to provide the disclosed functionalities. Either or both may also be implemented in software or a combination of software and hardware.

In certain embodiments, the electronic display device may display 3D images to be viewed by wearing 3D glasses. That is, the viewer is required to wear the 3D glasses to view the 3D images displayed by the electronic display device. FIG. 11 shows an imaging process of the expanded display apparatus using 3D glasses.

As shown in FIG. 11, points ‘a’ and ‘b’ are two points with parallax on plane 101 of the display screen of the electronic display device. Through the glasses, the viewer sees image points a′ and b′ of the points ‘a’ and ‘b’ behind the transmissive/reflective lens surface 102. If the light from point ‘a’ enters the right eye through the right lens of the glasses, and the light from point ‘b’ enters the left eye through the left lens of the glasses, the angle between the plane 101 and the transmissive/reflective lens surface 102 can be set such as the light from points ‘a’ and ‘b’ enters into the glasses of the viewer by being reflected by the transmissive/reflective lens surface 102. The viewer can wear the glasses and view the 3D image point E formed by the points a′ and b′ behind the transmissive/reflective lens surface 102.

When displaying 3D images viewable by 3D glasses, the display screen of the electronic display device may include an LCD display screen with a high refresh rate and supporting shutter glasses, or an LCD display screen with different polarization states for odd/even rows or odd/even column and supporting polarized glasses.

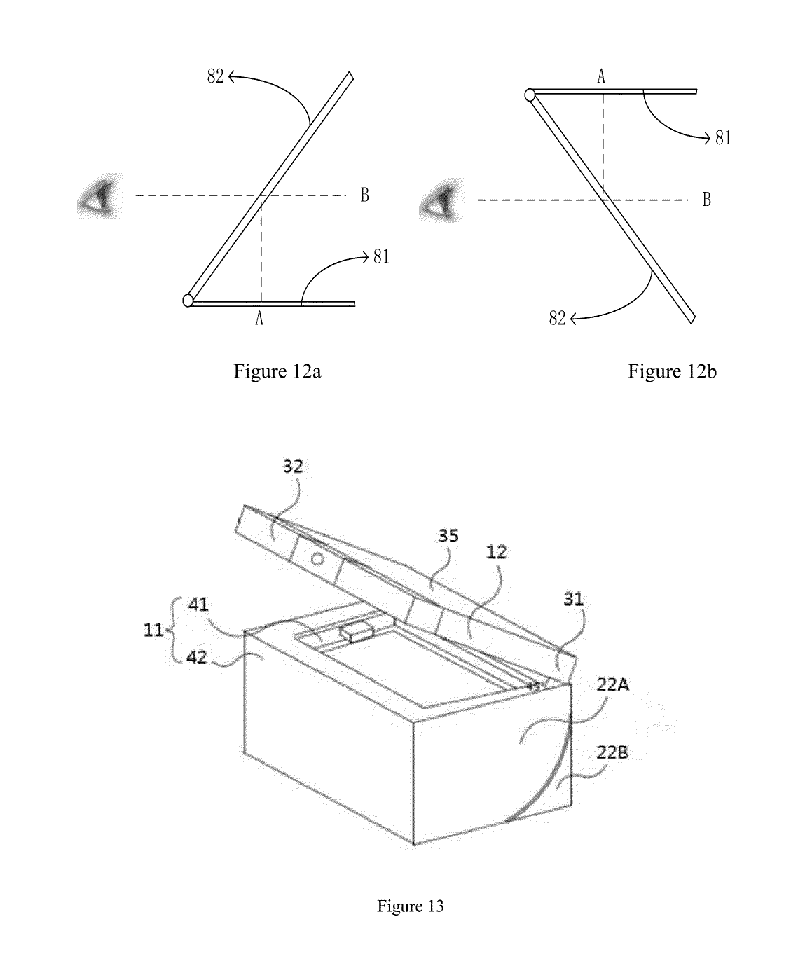

FIG. 12a and FIG. 12b shows another exemplary expanded display apparatus. As shown in FIG. 12a, the expanded display apparatus may include a support member 81 for placing the electronic display device and a transmissive/reflective device 82. The support member 81 is connected with the transmissive/reflective device 82, with an angle of less than 90 degrees between. The transmissive/reflective device 82 expands the image displayed by the electronic display device. During the expanded display, the support member 81 is on the side of the first surface of the transmissive/reflective device 82.

The support member 81 may be disposed below the transmissive/reflective device 82, as shown in FIG. 12a. The support member 81 can be used to place the electronic display device and, at the same time, can also support the transmissive/reflective device 82. After placing the electronic display device on the support member 81, the user can see images behind transmissive/reflective device 82. That is, the user can see the image of A from the point B behind the transmissive/reflective device 82.

Alternatively, as shown in FIG. 12b, the support member 81 can also be disposed above the transmissive/reflective device 82 and be used to place the electronic display device. When in use, an external support frame or slot may be used to support the expanded display apparatus. After placing the electronic display device on the support member 81, the user can see images behind transmissive/reflective device 82. That is, the user can see the image of A from the point B behind the transmissive/reflective device 82. The details of specific structures and connections may be referred to those described previously.

FIG. 13 illustrates another exemplary expanded display apparatus. As shown in FIG. 13, the expanded display apparatus may include a body structure 11, a transmissive/reflective device 12, and a moveable connecting structure (not shown). Other components may also be included.

The body structure 11 may include a receiving structure 41 and a support structure 42. The receiving structure 41 is configured to house the electronic display device. The transmissive/reflective device 12 may include a connecting end 31 and a free end 32 opposite to the connecting end 31, and the transmissive/reflective device 12 also includes a first surface (not labeled) and a second surface 35 opposite to the first surface. The first surface faces the receiving structure 41.

The connecting end 31 of the transmissive/reflective device 12 is moveably coupled to the support structure 42 through the moveable connecting structure. When the expanded display apparatus is in a display state, a virtual image of the image displayed by the electronic display device can be formed on the side of the second surface 35 of the transmissive/reflective device 12.

The support structure 42 may be a hollow box body and, when the transmissive/reflective device 12 folds and covers the receiving structure 41 and the support structure 42. A receiving slot with at least one opening side is disposed on the support structure 42. The receiving structure can be the receiving slot on the support structure 42, such that light from the image displayed on the display screen of the electronic display device can enter the transmissive/reflective device 12.

The support structure 42 includes a first sliding end 22A and a second sliding end 22B corresponding to the first sliding end 22A. The connecting end 31 of the transmissive/reflective device 12 may be moveably connected to the first sliding end 22A of the support structure 42 through the moveable connecting structure. When the transmissive/reflective device 12 folds and covers the support structure 42, the electronic display device is contained in the receiving structure 41.

The transmissive/reflective device 12 may be a device that has a surface coating and whose transmissive/reflecting ratio can be adjusted according to the ambient light. With a power supply, the transmissive/reflective device 12 can also be a liquid crystal glass device (also known as electronically-controlled liquid crystal glass). When power is applied, the transmissive rate (or transmittance) can be adjusted by adjusting the voltage of the device to adapt to changing light environment.

Further, the moveable connecting structure between the transmissive/reflective device 12 and the support structure 42 may include a connecting positioning shaft on the edge of the connecting end 31 of the transmissive/reflective device 12 and a connecting positioning sleeve on the support structure 42. The positioning shaft has a positioning protrusion, and a corresponding positioning groove is located on the inner side of the positioning sleeve. The positioning shaft can be inserted into the positioning sleeve, with the positioning protrusion engaged in the positioning groove.

Alternatively, the positioning shaft may be disposed on the support structure 42, and the corresponding positioning sleeve may be disposed on the connecting end 31 of the transmissive/reflective device 12. Also, the positioning protrusion may be located on the positioning sleeve and the corresponding positioning groove may be located on the positioning shaft. Other structures may also be used for the moveable connecting structure, including other rotary positioning structures, such hinge structures.

In operation, under an external force, the transmissive/reflective device 12 rotates against the body structure 11 (e.g., the supporting structure 42) to cause the display screen of the electronic display device housed in the receiving structure 41 to form a predetermined angle with the first surface of the transmissive/reflective device 12. Thus, a virtual image of the image displayed by the electronic display device can be generated on the side of the second surface 35 of the transmissive/reflective device 12. For example, the predetermined angle may be approximately 45 degrees. When there is no need for display, the transmissive/reflective device 12 folds and covers the receiving structure 41 and the electronic display device.

Further, the body structure 11 can also include a viewing angle adjusting mechanism 22. The viewing angle adjustment mechanism may be realized by the moveable connecting structure, e.g., by rotating the transmissive/reflective device 12 with respect to the support structure 42 to adjust the viewing angle. Further, the viewing angle adjusting mechanism may be disposed at the bottom of the support structure 42, such that all of the receiving structure 41, the transmissive/reflective device 12, and the support structure 42 can rotate with respect to the viewing angle adjusting mechanism, and the positions among the receiving structure 41, the transmissive/reflective device 12, and the support structure 42 are kept unchanged. Thus, the imaging space of the virtual images is not changed while realizing the viewing angle adjustment functionalities.

Additionally and/or optionally, on each side, a slider may be disposed on the first sliding end 22A, a corresponding groove matching the slider may be disposed on the second sliding end 22B. A positioning structure may also be include, such as a positioning steel ball and an elastic member (not shown) fixing the positioning steel ball on the bottom of the groove. When maintaining the relative position between the receiving structure 41 and the transmissive/reflective device 12, but by maneuvering the first sliding end 22A or the second sliding end 22B of the support structure 42, the first sliding end 22A can slide a certain distance along the groove with respect to the second sliding end 22B, thereby changing or adjusting the viewing angle.

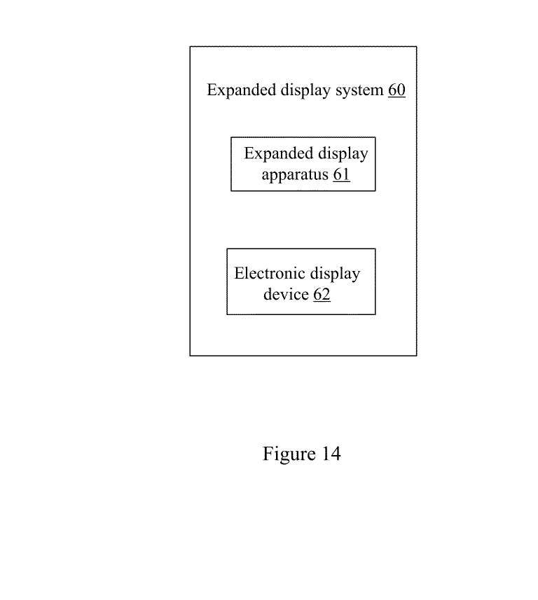

FIG. 14 illustrates an expanded display system. As shown FIG. 14, an expanded display system 60 includes an expanded display apparatus 61 and an electronic display device 62. The expanded display apparatus 61 may include any or a combination of disclosed expanded display apparatus.

For example, the expanded display system 60 may include all or part of the first image processing unit 20, the tracking unit 21, and the second image processing unit 22. The first image processing unit 20, the tracking unit 21, and the second image processing unit 22 may all be provided in the expanded display apparatus 61, may all be provided in the electronic display device 62; or may be partially provided in the expanded display apparatus 61 and partially provided in the electronic display device 62.

For example, the first image processing unit 20 and the tracking unit 21 may be provided on the expanded display apparatus 61 while the second image processing unit 22 is provided on the electronic display device 62. Or the first image processing unit 20 may be provided on the expanded display apparatus 61 while the tracking unit 21 and the second image processing unit 22 is provided on the electronic display device 62. Or the tracking unit 21 and the second image processing unit 22 may be provided on the expanded display apparatus 61 while the first image processing unit 20 is provided on the electronic display device 62, so on and so forth.

Thus, by using the disclosed expanded system, the expanded display apparatus provides expanded display of images displayed by the electronic display device placed on the upper support member through a transmissive/reflective device having a less than 90 degree angle with the upper support member. Because the transmissive functionality of the transmissive/reflective device, the viewer in front of the transmissive/reflective device can view a display unlimited by the display frame and integrated with the real scene surrounding the display apparatus, giving the viewer a realistic and immersive feel and improving the viewer's viewing experience. In addition, the transmissive/reflective device may be provided without a frame to generate an effect of transparent display screen without frame, which is less likely to cause eyesight fatigue. Further, the disclosed expanded display apparatus may utilize simple manufacturing processes, have low cost, and easy for mass production.

The above-described embodiments are merely illustrative, and are not limiting. Those skilled in the art can understand that various modifications to these embodiments will be readily apparent, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein. Other applications, advantages, alternations, modifications, or equivalents to the disclosed embodiments are obvious to those skilled in the art.

What is claimed is:

1. An expanded display apparatus to expand display of an electronic display device, comprising:
an upper support member configured to receive the electronic display device having a display screen for displaying an image by the electronic display device;
a lower support member; and
a transmissive/reflective device connected between the upper support member and the lower support member,
wherein the upper support member and the transmissive/reflective device form a less than 90 degree angle, and the transmissive/reflective device generates a virtual image of the image displayed by the electronic display device, merged with scenes surrounding the expanded display apparatus, to be viewed by a viewer at the viewing angle.

2. The expanded display apparatus according to claim 1, wherein:
the transmissive/reflective device includes a first surface and a second surface opposite to the first surface; and
when the transmissive/reflective device generates the virtual image, the upper support member is on the first surface side and the lower support member is on second surface side.

3. The expanded display apparatus according to claim 1, further including:
a first image processing unit configured to perform mirror image processing on the image displayed by the electronic display device along a center axis.

4. The expanded display apparatus according to claim 3, wherein the electronic display device displays an autostereoscopic 3D image, the expanded display apparatus further including:
a tracking unit configured to obtain position information of the viewer; and
a second image processing unit configured to rearrange image information to be displayed by the electronic display device according to the position information of the viewer.

5. The expanded display apparatus according to claim 4, further including:
a display control screen disposed on the upper support member or the lower support member, configured to display control information corresponding to the image displayed by the electronic display device and to control display content of the electronic display device based on feedback on the control information.

6. The expanded display apparatus according to claim 4, wherein:
the less than 90 degree angle is in a range of 30 degrees to 60 degrees.

7. The expanded display apparatus according to claim 4, wherein:
the upper support member is fixedly connected to the transmissive/reflective device;
the transmissive/reflective device is fixedly connected to the lower support member; and
the upper support member is in parallel to the lower support member.

8. The expanded display apparatus according to claim 4, wherein:
the upper support member is moveably connected to the transmissive/reflective device.

9. The expanded display apparatus according to claim 8, wherein:
the transmissive/reflective device is moveably connected to the lower support member.

10. An expanded display apparatus to expand display of an electronic display device, comprising:
a support member configured to receive the electronic display device having a display screen for displaying an image by the electronic display device; and
a transmissive/reflective device connected to the support member with a less than 90 degree angle,
wherein the transmissive/reflective device generates a virtual image of the image displayed by the electronic display device, merged with scenes surrounding the expanded display apparatus, to be viewed by a viewer at the viewing angle.

11. The expanded display apparatus according to claim 10, wherein:
the transmissive/reflective device includes a first surface and a second surface opposite to the first surface; and
when the transmissive/reflective device generates the virtual image, the support member is on the first surface side and the virtual image is formed on the second surface side.

12. The expanded display apparatus according to claim 10, further including:
a first image processing unit configured to perform mirror image processing on the image displayed by the electronic display device along a center axis.

13. The expanded display apparatus according to claim 12, wherein the electronic display device displays an autostereoscopic 3D image, the expanded display apparatus further including:
a tracking unit configured to obtain position information of the viewer; and
a second image processing unit configured to rearrange image information to be displayed by the electronic display device according to the position information of the viewer.

14. The expanded display apparatus according to claim 13, further including:
a display control screen disposed on the support member and configured to display control information corresponding to the image displayed by the electronic display device and to control display content of the electronic display device based on feedback on the control information.

15. The expanded display apparatus according to claim 14, wherein:
the less than 90 degree angle is in a range of 30 degrees to 60 degrees.

16. The expanded display apparatus according to claim 14, wherein:
the support member is located under the transmissive/reflective device to support the transmissive/reflective device.

17. The expanded display apparatus according to claim 16, further including:
the support member is located above the transmissive/reflective device, and
an external support frame is provided to support the support member and the transmissive/reflective device.

18. The expanded display apparatus according to claim 16, wherein:
the support member is moveably connected to the transmissive/reflective device.

19. An expanded display system, comprising:
an electronic display device having a display screen for displaying an image by the electronic display device; and
an expanded display apparatus to expand display of an electronic display device, including:
a first support member configured to receive an electronic display device; and
a transmissive/reflective device connected to the first support member with a less than 90 degree angle,
wherein the transmissive/reflective device generates a virtual image of the image displayed by the electronic display device, merged with scenes surrounding the expanded display apparatus, to be viewed by a viewer at the viewing angle.

20. The expanded display system according to claim 19, wherein the electronic display device displays an autostereoscopic 3D image and the expanded apparatus further includes:
a second support member configured to support the first support member and the transmissive/reflective device;
a first image processing unit configured to perform mirror image processing on the image displayed by the electronic display device along a center axis;
a tracking unit configured to obtain position information of the viewer;
a second image processing unit configured to rearrange image information to be displayed by the electronic display device according to the position information of the viewer; and
a display control screen configured to display control information corresponding to the image displayed by the electronic display device and to control display content of the electronic display device based on feedback on the control information.
